(19) United States
(12) Patent Application Publication
(10) Pub. No.: US 2005/0248125 A1
(43) Pub. Date: Nov. 10, 2005

(54) Vehicle attachment device

(76) Inventors: Errol W. Flynn, Alto, MI (US); Judy J. Flynn, Alto, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/920,853

(22) Filed: Aug. 18, 2004

Related U.S. Application Data
(60) Provisional application No. 60/568,058, filed on May 4, 2004.

(51) Int. Cl. B60D 1/00

(52) U.S. Cl. 280/491.3

(57) ABSTRACT

A vehicle attachment device including a connector for attaching the vehicle attachment device to a vehicle is provided. The device further includes a first separator positioned between the first end of the connector and the vehicle. The device also includes a rigid mount section including a first end rigidly mounted to a first separator and the second end of the connector. The rigid mount section includes a hinged portion second end. A receptacle is hingedly attached to this hinged portion of the rigid mount section. The hinged attachment is capable of generally 180° of movement, relative to the vehicle to which it is attached. This generally 180° of movement is measured from the vehicle attachment device in its generally non-use position. The device includes at least two wheels, wherein the wheels are independently connected to the receptacle and capable of movement about both a horizontal and a vertical axis.

### CROSS-REFERENCE TO RELATED APPLICATIONS

This application claims the benefit of U.S. Provisional Patent Application No. 60/568,058, filed May 4, 2004, the disclosure of which is hereby incorporated by reference in its entirety.

### BACKGROUND OF THE INVENTION

The present invention is directed toward a vehicle attachment device, wherein the device is typically utilized to carry or store objects.

Various vehicle attachment devices are known. These devices typically include a variety of trailer or trailing devices. One such device is a vehicle trailer that includes a hinged tongue, wherein the trailer may move in only one generally vertical direction with respect to the vehicle to which it is attached. That is to say, the carrying portion of the trailer may be positioned in generally an upward, stored 90° angle position relative to the tongue of the trailer. However, the hinged connection connecting the tongue to the remainder of the trailer only allows the trailer to move in this one generally vertical direction (i.e., generally a 90° “upright” storage position), thereby substantially limiting the ability of the trailer, which is attached to a vehicle, to traverse rough terrain. Such a trailer also includes one or more fixed wheels that are only capable of moving about a horizontal axis.

Surprisingly, Applicants have discovered a novel vehicle attachment device that eliminates the need for the skills required to backup a trailer. The attachment device remains rigidly and permanently connected to the vehicle when traversing uneven ground (i.e., rolling hills, ravines, or other fluctuations in land) and, while remaining attached to the vehicle, may be easily stored in a non-use position.

### SUMMARY OF THE INVENTION

One aspect of the present invention includes a vehicle attachment device. The device includes a connector for attaching the vehicle attachment device to a vehicle. The device further includes a first separator positioned between the connector and the vehicle. The device also includes a rigid mount section including a first end rigidly mounted to a separator and the connector. The rigid mount section includes a second end having a hinged portion attached thereto. A receptacle is hingedly attached to this hinged portion of the rigid mount section. The hinged attachment is capable of generally 180° of movement, relative to the vehicle to which it is attached. The device also includes at least two wheels, which are independently connected to the receptacle. Each wheel is capable of movement about both a horizontal and a vertical axis.

These and other features, advantages, and objects of the present invention will be further understood and appreciated by those skilled in the art by reference to the following specification, claims, and appended drawings.

### BRIEF DESCRIPTION OF THE DRAWINGS

FIG. 1 is a perspective view of the vehicle attachment device connected to an all-terrain vehicle according to one aspect of the present invention;

FIG. 2 is an exploded perspective view of the connection between the vehicle attachment device and a vehicle according to one aspect of the present invention;

FIG. 3 is a partial side plan view of the connection between the vehicle attachment device (in its non-use position) and a vehicle according to one aspect of the present invention; and

FIG. 4 is a partial side plan view of the vehicle attachment device (in its use position) connected to an all-terrain vehicle according to one aspect of the present invention.

### DETAILED DESCRIPTION OF PREFERRED EMBODIMENT

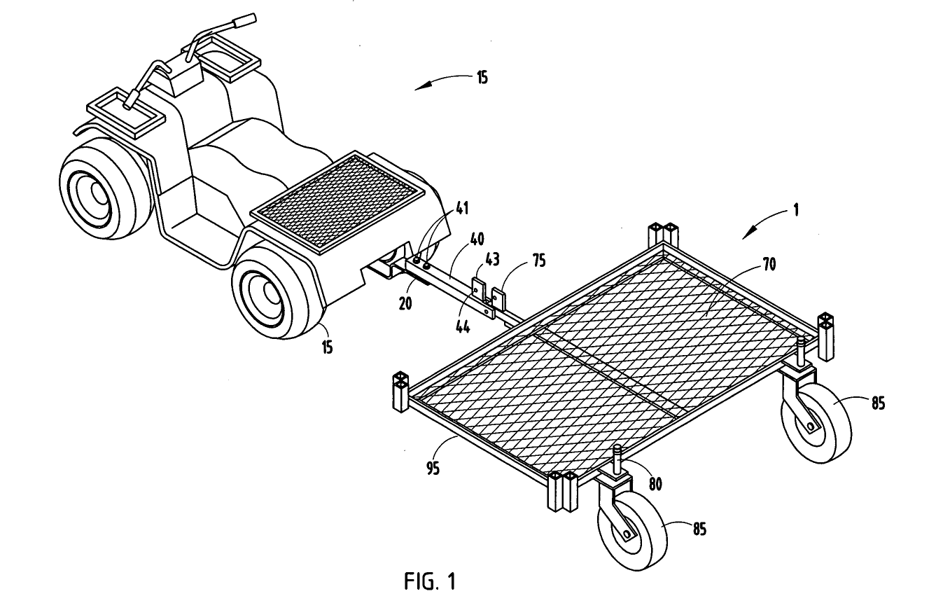

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings and described in the following specification are exemplary embodiments of the inventive concepts defined in the appended claims. Hence, specific dimensions and other physical characteristics relating to the embodiments disclosed herein are not to be considered as limiting, unless the claims expressly state otherwise.

Referring to FIG. 1, reference number 1 designates one embodiment of the vehicle attachment device of the present invention including a connector, a rigid mount section, a receptacle portion hingedly connected thereto (i.e., capable of moving in a generally vertical direction about the hinge connection) and at least two or more wheels independently connected to the receptacle portion, wherein the wheels are capable of moving about both a horizontal and a vertical axis. Reference numeral 15 is an all-terrain vehicle to which the vehicle attachment device 1 of the present invention is permanently attached.

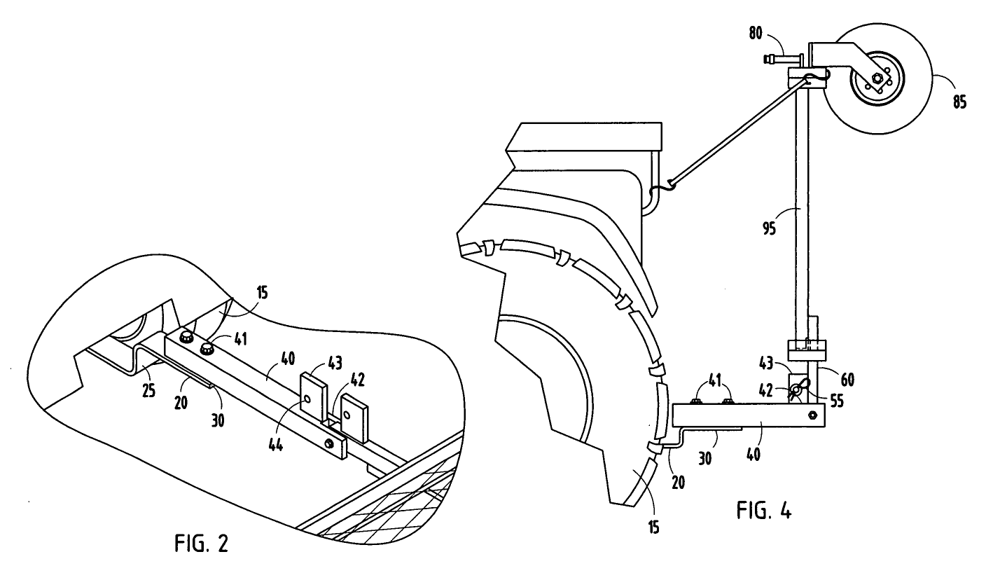

Referring to FIG. 2, connector 20 includes a first end 25 and a second end 30. Connector 20 permanently attaches to all-terrain vehicle 15 at first end 25. The permanent attachment referred to herein is an attachment including, but not limited to, a bolted attachment, a welded attachment, a tension clamped attachment, etc., wherein each of these attachments is not capable of a conventional “ball and hitch” movement found in conventional trailer-vehicle connections. Typically, bolting first end 25 of connector 20 to all-terrain vehicle 15 is preferred. First end 25 of connector 20 may be bolted to either the top or the bottom of the all-terrain vehicle receiver. While connector 20 may be permanently connected directly to a portion of the all-terrain vehicle rigid body (i.e., frame) or the all-terrain vehicle receiver, it is preferred that first separator 35 be placed between the all-terrain vehicle 15 and first end 25 of connector 20. First separator 35 alleviates a metal-on-metal connection and keeps the permanent attachment (i.e., bolted attachment) from loosening. Connector 20 may be utilized in any of the above-discussed permanent attachments. Connector 20 may be any shape, including, but not limited to, a “Z” shape, an “S” shape, rectangularly shaped, etc. A “Z” shape or an “S” shape is preferred. Connector 20 may also be shaped to allow for differences in height of the all-terrain vehicle rigid body (i.e., frame) or the all-terrain vehicle receiver and rigid mount section 40 of attachment device 1. That is to say, connector 20 may be shaped to generally extend in generally an upward direction or generally downward direction, relative to the all-terrain vehicle rigid body or the all-terrain vehicle receiver, so that the vehicle attachment device 1, when attached to the all-terrain vehicle, is generally horizontally positioned relative to the ground upon which the device sits. Connector 20 may be made of any materials including, but not limited to, metal, plastic, wood or combinations or derivations of any of the above materials. However, typically, metal is preferred.

First separator 35 may include, but is not limited to, gaskets, bushings, etc. Typically, gaskets are typically preferred. First separator 35 may be constructed of any material including, but not limited to, rubber, plastic, soft metals, foams or any combinations or derivations of any of the above. Typically, rubber is the preferred construction material. First separator 35 may be any shape, however, typically a rectangular shape is preferred.

The second end 30 of connector 20 is permanently attached to the first end 41 of rigid mount section 40. Connector 20 may be connected to either the top or the bottom of rigid mount section 40. This permanent attachment may be any type as described above. Similar to the connection between first end 25 of connector 20 and the all-terrain vehicle rigid body (i.e., frame) or the all-terrain vehicle receiver, the connection between the second end 30 of connector 20 and first end 41 of rigid mount section 40 may be separated by second separator 45. While this is not necessary, it is preferred. Second separator 45 may be any shape, however, a rectangular shape is preferred. Typically, second separator 45 is constructed of materials as described above relative to first separator 35 and rubber is the preferred construction material.

Rigid mount section 40 may be any length, however a length range of from about 3 inches to about 18 inches is preferred, while a range of from about 4 inches to about 12 inches is most preferred. Rigid mount section 40 may be comprised of any material, including, but not limited to, metal, plastic, wood or any combinations or derivations thereof. Typically, metal or plastic is preferred. Rigid mount section 40 includes a first end 41 and a second end 42. As discussed above, first end 41 is permanently connected to second end 30 of connector 20.

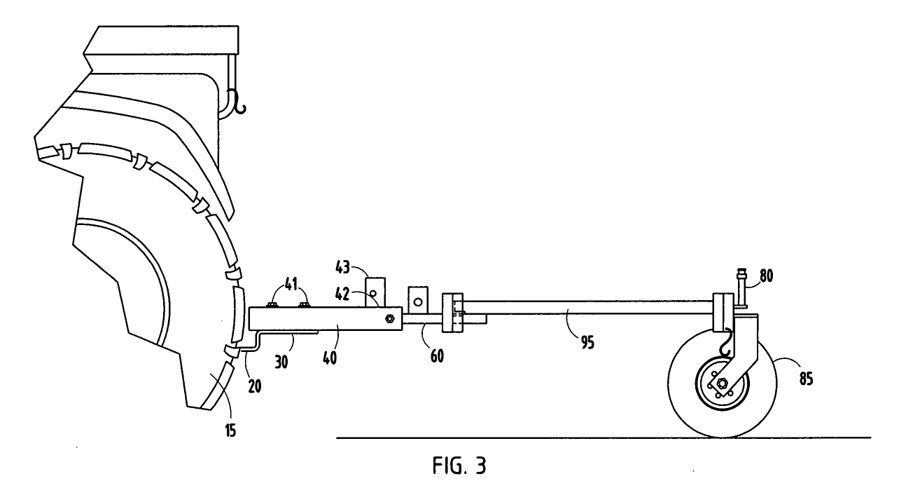

Second end 42 of rigid mount section 40 includes one or more receiving flanges 43, each having one or more apertures 44 therethrough. Second end 42 is hingedly attached to tongue 60 on receptacle portion 50 (see FIG. 3). Therefore, rigid mount section 40 remains in a generally horizontal position, relative to the ground upon which vehicle attachment device 1 is sitting, while receptacle 50 may move about hinge connection 55 in generally a vertical direction. That is to say, receptacle portion 50 may move in an upward or downward direction relative to the ground, but generally cannot move in a horizontal direction (i.e., from side to side behind the vehicle). In use, this hinged connection 55 allows receptacle portion 50 to move in an upward or downward direction, relative to the ground device 1 is traversing. Typically, hinged connection 55 allows device 1 to be utilized in much more steep environments (i.e., steep land fluctuations) than conventional releasably mounted trailers that are connected to a vehicle via a conventional “ball and hitch” connection. This hinged connection 55 allows receptacle portion 50 to move to a position approximately 180 degrees in a downward, away from the vehicle direction, in relation to rigid mount section 40, as measured from the device 1 being in its generally non-use position (see FIG. 4).

Referring to FIG. 3, receptacle portion 50 includes tongue 60. Tongue 60 includes one or more second receiving flanges 65. Much like the one or more first receiving flanges 43, the one or more second receiving flanges 65 includes one or more apertures 66 therethrough. When vehicle attachment device 1 is in its useable position (see FIG. 1), one or more first receiving flanges 43 and one or more second receiving flanges 65 are not in use. Alternatively, when device 1 is in its stored position (see FIG. 4), the one or more apertures 44 of one or more first receiving flanges 43 are substantially aligned with the one or more flange apertures 66 of second receiving flanges 65. While any type of connection may be utilized to hold the device 1 in a substantially non-useable position (see FIG. 4), most typically a holding pin, or the like, is inserted through the above-mentioned apertures to hold device 1 in a non-useable position (see FIG. 4).

Receptacle portion 50 includes a receiving portion 70 (see FIG. 1). Receiving portion 70 includes a first end 75 and a second end 80. First end 75 is attached to tongue 60 (see FIG. 3), via any type of connection, however, typically a weld connection is preferred. Second end 80 of receiving portion 70 includes two or more independent wheels 85 capable of moving both about a horizontal axis and a vertical axis (see FIG. 1). Alternatively, wheels 85 may be positioned on the third 90 and fourth 95 ends of receiving portion 70, or they may be positioned under receiving portion 70. Also, wheels 85 may include four independent wheels positioned at approximately the four corners of the generally rectangularly-shaped receptacle portion 50. Receiving portion 70 may include, but is not limited to, a substantially flat carrying surface, a carrying surface having side Walls, a substantially flat carrying surface adapted to optionally include side walls, etc., or any combinations or derivations of any of the above. Such a receiving portion 70 may be any shape including, but not limited to, rectangular, square, round, etc. Typically, a rectangular shape is preferred. Receiving portion 70 may be constructed of any material, including, but not limited to, metal, plastic, wood, etc., or any combination or derivations of any of these. Typically, metal or plastic is preferred.

Device 1 of the present invention may be attached to the front or the rear of a vehicle.

Regardless of whether device 1 is attached to the front or rear of a vehicle, a user may move the vehicle in a forward direction or reverse the vehicle without regard to controlling the direction of the device. In other words, because the device is rigid mounted and includes wheels capable of moving about both a horizontal and a vertical axis, a user can move the vehicle forward or reverse the vehicle having the device attached thereto without utilizing conventional trailering skills required to maneuver a trailer connected to a vehicle via a conventional ball and hitch connection. The present invention is advantageous because when reversing a vehicle having device 1 attached thereto, a user can do so without utilizing the conventional trailering skills required to reverse a vehicle having a trailer attached thereto via a conventional ball and hitch connection. This eliminates a user “jack-knifing” the trailer.

Applicants have surprisingly discovered a novel vehicle attachment device that eliminates the need for the skills required to backup a trailer, that remains rigidly and permanently connected to the vehicle when traversing uneven ground (i.e., rolling hills, ravines, or other fluctuations in land) and that, while remaining attached to the vehicle, may be easily stored in a non-use position.

In the foregoing description, it will be readily appreciated by those skilled in the art that modifications may be made to the invention without departing from the concepts disclosed herein. Such modifications are to be considered as included in the following claims, unless these claims by their language expressly state otherwise.

1. A vehicle attachment device comprising:
a connector for attaching the vehicle attachment device to a vehicle, wherein the connector includes a first end and a second end;
a first separator positioned substantially between the first end of the connector and a vehicle to which the vehicle attachment device is attached;
a rigid mount section including a second separator positioned substantially between the second end of the connector and the rigid mount section, wherein the rigid mount section includes a first end rigidly mounted to the second separator and the second end of the connector, and a second end including a hinged portion;
a receptacle hingedly attached to at least a portion of the hinged portion of the second end of the rigid mount section, wherein at least a portion of the hinged portion may generally move in about 180° of vertical movement, relative to the vehicle to which the device is attached, as measured from the vehicle attachment device in its generally non-use position; and
at least two wheels, wherein the wheels are independently connected to the receptacle and each wheel is capable of movement about both a horizontal and a vertical axis.

2. The vehicle attachment device of claim 1, wherein the receptacle further includes one or more slots for receiving at least a portion of one or more sidewalls.

3. The vehicle attachment device of claim 2, wherein the receptacle is generally rectangularly shaped.

4. The vehicle attachment device of claim 3, including four wheels, wherein the wheels are independently connected to the receptacle and each wheel is capable of movement about both a horizontal and a vertical axis.

5. An all-terrain vehicle comprising:
a connector for attaching a vehicle attachment device to an all-terrain vehicle, wherein the connector includes a first end and a second end;
a first separator positioned substantially between the first end of the connector and the all-terrain vehicle;
a rigid mount section including a second separator positioned substantially between the second end of the connector and the rigid mount section, wherein the rigid mount section includes a first end rigidly mounted to the second separator and the second end of the connector, and a second end including a hinged portion;
a receptacle hingedly attached to the second end of the rigid mount section, wherein the hinged portion is capable of generally 180° of vertical movement, relative to the all-terrain vehicle to which it is attached, as measured from the vehicle attachment device in its generally non-use position; and
at least two wheels, wherein the wheels are independently connected to the receptacle and each wheel is capable of movement about both a horizontal and a vertical axis.

6. The all-terrain vehicle of claim 5, wherein the receptacle further includes one or more slots for receiving at least a portion of one or more sidewalls.

7. The all-terrain vehicle of claim 6, wherein the receptacle is generally rectangularly shaped.

8. The all-terrain vehicle of claim 7, including four wheels, wherein the wheels are independently connected to the receptacle and each wheel is capable of movement about both a horizontal and a vertical axis.
